(19) United States
(12) Patent Application Publication
(10) Pub. No.: US 2010/0247839 A1
(43) Pub. Date: Sep. 30, 2010

(54) OPTICAL DEVICE

(75) Inventors: Naoki HAYASHIDA, Tokyo (JP); Atsuko KOSUDA, Tokyo (JP); Motohiro INOUE, Tokyo (JP); Jiro YOSHINARI, Tokyo (JP)

Correspondence Address: OLIFF & BERRIDGE, PLC, P.O. BOX 320850, ALEXANDRIA, VA, 22320-4850, US

(73) Assignee: TDK CORPORATION, TOKYO (JP)

(21) Appl. No.: 12/708,052

(22) Filed: Feb. 18, 2010

(30) Foreign Application Priority Data
Mar. 26, 2009 (JP) 2009-077305

(51) Int. Cl. B32B 3/02

(52) U.S. Cl. 428/64.4

(57) ABSTRACT

A hologram recording medium includes a glass substrate and an information recording layer supported on the glass substrate. The information recording layer is formed of a photosensitive material having a dynamic storage elastic modulus of 1.0×10⁵ Pa or more as measured at 80° C. and a measurement frequency of 1 Hz after interference exposure or post-curing. The photosensitive material is dissolvable or dispersible in an organic solvent, and the information recording layer has sufficient storage stability that allows recorded signals to be stably held for at least 100 hours or longer at 80° C.

### BACKGROUND OF THE INVENTION

1. Field of the Invention

The present invention relates to an optical device having sufficient storage stability.

2. Description of the Related Art

In conventional hologram recording materials that allow recording only once (i.e., write-once hologram recording materials) disclosed in Japanese Patent No. 3737306, WO2005/78531, WO2005/78532, and Japanese Patent Application Laid-Open No. 2008-70464, a photopolymerizable monomer is dispersed in a polymer matrix that is three-dimensionally cross-linked through covalent bonds. Such materials are used because it is believed that the formation of the matrix used as a dispersion medium for the photopolymerizable monomer by three-dimensional cross-linking through covalent bonds is most effective to simultaneously achieve high recording sensitivity, high dynamic range, and less recording shrinkage.

It is also believed that the matrix three-dimensionally cross-linked through covalent bonds is effective to ensure temporal stability after signals are recorded. This is because the skeleton of the three-dimensionally cross-linked polymer matrix itself is considered to be advantageous to simultaneously provide both mechanical strength and the mobility of the photopolymerizable monomer, which are generally traded off against each other. In addition, the polymerization of the photopolymerizable monomer in the three-dimensionally cross-linked polymer matrix (this means that signals are recorded) results in the formation of a so-called Interpenetrating Polymer Network (IPN), and this is considered to provide a further improvement in the mechanical strength of the recording material, i.e., the storage stability of the recorded signals.

Moreover, it is believed that the formation of the IPN is effective to simultaneously achieve both a high degree of refractive index modulation (Δn) and the compatibility of the photopolymerized monomer or the polymer thereof with the matrix.

The compatibility is determined by the solubility parameters (SP values) of the components to some extent, and the SP values are inversely proportional to the polarizabilities and molar volumes of the molecules, so that the compatibility is also correlated with the refractive indexes of the materials. Therefore, the increase in Δn and the increase in the compatibility are often traded off against each other.

The three-dimensional cross-linking of the matrix, however, does not always provide the desired storage stability. The storage stability is considered to be practically acceptable if recorded signals are stably stored for at least 100 hours or longer at 80° C. However, data explicitly showing that the above storage stability is achieved particularly in a multiplex recorded state has not been reported (see Japanese Patent Application Laid-Open Nos. Hei. 06-202541, 2007-279585, 2007-316570, and 2008-139768). For example, in Japanese Patent Application Laid-Open No. Hei. 06-202541, there is a description of the temporal stability of a single diffraction peak without multiplex recording, and the stability after seven days at 90° C. is described. However, no data for multiplex recording is given.

### SUMMARY OF THE INVENTION

In view of the foregoing problems, various exemplary embodiments of this invention provide an optical device having sufficient storage stability, i.e., allowing recorded signals to be stably stored for at least 100 hours or longer at 80° C.

The present inventors have made intensive studies and found that three-dimensional cross-linking of the matrix through covalent bonds is not absolutely necessary to ensure sufficient storage stability and that sufficient storage stability can be ensured by, for example, forming the three-dimensional cross-linking structure of the matrix through weak intermolecular force such as hydrogen bonding or Van der Waals force.

Moreover, the inventors have arrived at a conclusion that the degree of the temporal stability is determined not by the type of the cross-linking but by the elastic modulus of a recording material. More specifically, the inventors have found that, when the recording material that forms an information recording layer has a predetermined dynamic storage elastic modulus after exposure for recording or post-curing following the exposure, sufficient storage stability can be achieved irrespective of whether the cross-linking in the matrix is formed through covalent bonds or through intermolecular force.

The inventors have also found the following. When a recording material is used which contains a radical-polymerizable monomer in an amount suitable for providing a sufficient dynamic range as an optical recording medium, the dynamic storage elastic modulus of the recording material before recording is closely correlated with the dynamic storage elastic modulus after the exposure for recording. In addition, when the dynamic storage elastic modulus before recording is equal to or greater than a predetermined value, the dynamic storage elastic modulus required after the exposure for recording or post-curing can be spontaneously achieved.

As used herein, the dynamic storage elastic modulus is an elastic modulus measured using a dynamic viscoelastic measuring apparatus with predetermined sinusoidal vibrations applied to a sample. Dynamic storage elastic moduli are classified into a dynamic tensile storage elastic modulus, a dynamic bending storage elastic modulus, a dynamic shear storage elastic modulus, a dynamic torsion storage elastic modulus, and the like, according to the deformation mode applied to the test piece during the measurement. Any of the elastic moduli may be used.

Dynamic storage elastic moduli measured in different deformation modes do not always agree. However, if the material used for the measurement is isotropic, the elastic moduli are substantially the same in the range where stress and strain are proportional to each other. In the present invention, the dynamic shear storage elastic modulus or the dynamic tensile storage elastic modulus is preferably used because they are suitable for measurement for general optical devices including optical recording mediums. More preferably, the dynamic shear storage elastic modulus is used.

Preferably, the dynamic shear storage elastic modulus (which may be simply referred to as a shear storage elastic modulus) is measured according to JIS K7244-10:2005 (1506721-10:1999). However, the shape of the measurement sample is not necessarily in the range recommended by the standards. Preferably, the dynamic tensile storage elastic modulus (which may be simply referred to as a tensile storage elastic modulus) is measured according to JIS K7244-4:1999 (1306721-4:1994).

In the present invention, the dynamic tensile storage elastic modulus can be used only when a free standing film of the recording material that has a shape suitable for the measurement can be obtained from the optical device. When the dynamic shear storage elastic modulus is used, the sample used is not necessarily composed only of the recording material. For example, when the optical device includes a recording material sandwiched between resin substrates, it is sufficient to peel off only one of the resin substrates with the other resin substrate remaining present on the recording material layer, so long as a measurement sample with at least part of the recording material layer exposed can be prepared. In this case, the recording material, together with the other resin substrate, is securely placed on the sample stage of a measuring apparatus, and the measurement is carried out using this sample.

Moreover, layers formed of other materials, such as a reflection film and a boding layer, may be present between the recording material layer and the resin substrates. In such a case, the dynamic storage elastic moduli of the resin substrates and the layers formed of other materials must be previously known. Preferably, the dynamic storage elastic modulus of the resin substrates is sufficiently greater than that of the recording material, but this is not an absolute requirement.

In the present invention, it is not always important to determine the exact value of the dynamic storage elastic modulus of the recording material, and it is sufficient to determine whether or not the elastic modulus is greater than a predetermined value. More specifically, when the dynamic storage elastic modulus of the recording material after interference exposure or post-curing is 1.0×10⁵ Pa or more and the dynamic storage elastic modulus of the recording material before the interference exposure is 1.0×10⁴ Pa or more, the determination of whether or not the recording material is acceptable is not influenced.

Polycarbonate and acrylic resin generally used for the resin substrates of optical devices, particularly optical recording mediums, have a dynamic storage elastic modulus of 1.0×10⁹ Pa or more, irrespective of the deformation modes. Generally, the shear peeling strength between the recording material layer and the resin substrates or between the recording material layer and the layers formed of other materials is sufficiently high and therefore does not influence the measurement.

In summary, the above-described objectives are achieved by the following embodiments of the present invention.

(1) An optical device, comprising: a supporting substrate; and an information recording layer that is supported on the supporting substrate and has a photosensitivity for recording a hologram by irradiation with light, wherein the information recording layer has a dynamic storage elastic modulus of 1.0×10⁵ Pa or more as measured at 80° C. and a measurement frequency of 1 Hz after interference exposure or post-curing.

(2) The optical device according to (1), wherein the information recording layer has a dynamic storage elastic modulus of 1.0×10⁴ Pa or more as measured at 80° C. and a measurement frequency of 1 Hz before the interference exposure.

(3) The optical device according to (1) or (2), wherein the information recording layer contains 5 percent by mass to 50 percent by mass of a radical-polymerizable monomer.

(4) The optical device according to any of (1) to (3), wherein the information recording layer is dissolvable or dispersible in an organic solvent.

According to the present invention, an optical device excellent in storage stability can be provided which is produced using a recording material having a controlled dynamic storage elastic modulus.

Moreover, since, unlike a conventional matrix formed by three-dimensional cross-linking through covalent bonds, the recording material can be dispersed or dissolved in a suitable organic solvent even after three-dimensional cross-linking is formed, any of various deposition processes suitable for mass production can be used.

### BRIEF DESCRIPTION OF THE DRAWINGS

FIG. 1 is a schematic cross-sectional view illustrating a hologram recording medium used in Examples of the present invention;

FIG. 2 is a schematic block diagram illustrating the structure of a hologram recording optical system used for the evaluation of the hologram recording mediums in the Examples of the invention and a Comparative Example;

FIG. 3 is a graph showing the temperature dependence profiles of the dynamic storage elastic modulus of the hologram recording medium in Example 1 of the invention;

FIG. 4 is a graph showing the diffraction profile of the hologram recording medium in Example 1 of the invention;

FIG. 5 is a graph showing the diffraction profile, after heating for a predetermined time, of the hologram recording medium in Example 1 of the invention;

FIG. 6 is a graph showing the temperature dependence profiles of the dynamic storage elastic modulus of the hologram recording medium in Example 2 of the invention;

FIG. 7 is a graph showing the diffraction profile of the hologram recording medium in Example 2 of the invention;

FIG. 8 is a graph showing the diffraction profile, after heating for a predetermined time, of the hologram recording medium in Example 2 of the invention;

FIG. 9 is a graph showing the temperature dependence profiles of the dynamic storage elastic modulus of the hologram recording medium in the Comparative Example of the invention;

FIG. 10 is a graph showing the diffraction profile of the hologram recording medium in the Comparative Example of the invention; and

FIG. 11 is a graph showing the diffraction profile, after heating for a predetermined time, of the hologram recording medium in the Comparative Example of the invention.

### DETAILED DESCRIPTION OF THE PREFERRED EMBODIMENTS

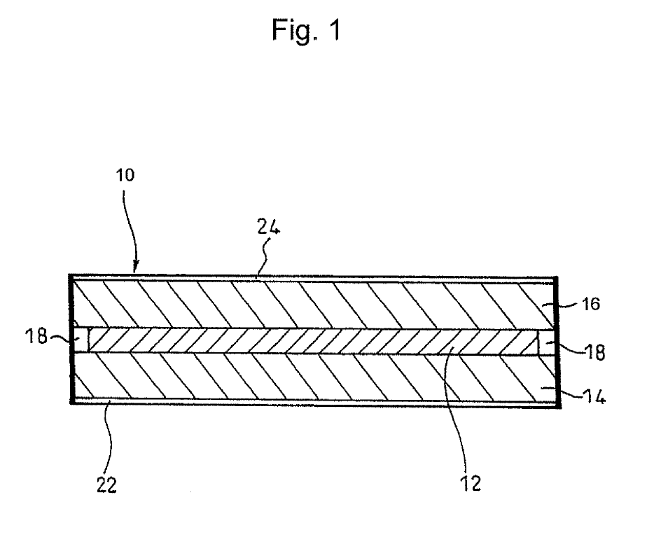

Hereinafter, a detailed description will be given of a hologram recording medium 10 in Example 1 of the present invention with reference to FIG. 1.

### Example 1

The hologram recording medium 10 is a transmission hologram recording medium, which is one of optical recording devices. The hologram recording medium 10 includes: an information recording layer (hologram recording material layer) 12; a spacer 18; and two glass substrates 14 and 16 used as supporting substrates that sandwich the information recording layer 12 and the spacer 18. Antireflection films 22 and 24 are formed on the lower side (in FIG. 1) of the glass substrate 14 and the upper side (in FIG. 1) of the glass substrate 16.

The glass substrates 14 and 16 are supporting substrates for holding the information recording layer 12 and allow light to transmit therethrough.

The spacer 18 is used to provide a spacing between the glass substrates 14 and 16 so as to allow the information recording layer 12 to be interposed therebetween.

The information recording layer 12 is obtained by coating the glass substrates 14 and/or 16 with a hologram recording material solution prepared, for example, by mixing a sol solution containing an organometallic matrix material with a photopolymerizable compound and allowing hydrolysis and condensation reaction to complete.

If the information recording layer 12 can be supported only by the glass substrate 14, the glass substrate 16 is not required.

The photosensitive material (hologram recording material) that forms the information recording layer 12 is obtained by first adding a radical-polymerizable monomer and a photopolymerization initiator to a sol (colloidal solution) obtained by hydrolysis and dehydration condensation (a so-called sol-gel method) of a metal alkoxide, and then removing the dispersion medium after deposition of the photosensitive material.

The matrix obtained by the above process contains metal-oxide-metal (M-O-M) bonds as main parts of the skeleton structure and is stable even at high temperatures. Therefore, by appropriately controlling the particle diameter of the sol, a recording material can be obtained which can be dispersed in an organic solvent and is excellent in storage stability.

More specifically, a metal alkoxide, a radical-polymerizable monomer, and a photopolymerization initiator are used as essential components, and additives such as a sensitizer and a plasticizer are added, if necessary. To obtain a photosensitive material (hologram recording material) from the above components, the following process, for example, is used.

First, the metal alkoxide is mixed with a dispersion medium, and small amounts of water and a hydrolysis catalyst are added to the mixture. The resultant mixture is stirred under appropriate conditions to allow hydrolysis and dehydration condensation to proceed. Preferred examples of the dispersion medium include: alcohols such as methanol, ethanol, propanol, and butanol; glycols such as ethylene glycol and propylene glycol; cellosolves such as ethylene glycol monomethyl ether and propylene glycol monomethyl ether; and ethers such as diethyl ether, tetrahydrofuran, and 1,3-dioxolane. Examples of the hydrolysis catalyst include acids such as hydrochloric acid, sulfuric acid, and acetic acid and bases such as triethylamine. The hydrolysis and dehydration condensation may be carried out, for example, under stirring for 30 minutes to several days in a temperature range of room temperature to 150° C. The radical-polymerizable monomer, the photopolymerization initiator, and, if necessary, additives are mixed with the thus-obtained organometallic sol. The resultant mixture is applied to a substrate using a commonly used coating method such as bar coating, gravure coating, die coating, spin coating, or dip coating to thereby form a film. Next, the obtained film is dried to remove the dispersion medium and to allow the condensation reaction of the unreacted metal alkoxide to complete, whereby a target recording film is obtained.

In an alternative process, only the sol obtained using the metal alkoxide is annealed or annealed and powdered, and then the radical-polymerizable monomer, the photopolymerization initiator, the additives, and the dispersion medium are added thereto, whereby a composition having controlled concentrations of non-volatile components and a controlled viscosity is prepared. A recording film is obtained by applying the prepared composition to a substrate. When the above process is used, any of various ketones and esters (in addition to the above-mentioned dispersion mediums such as alcohols, glycols, cellosolves, and ethers) may be preferably used as the dispersion medium. Since the condensation reaction has been completed after the sol is annealed, the time required for the drying step after coating can be reduced.

Specific examples of the metal alkoxide include metal alkoxides in which an organic group is directly bonded to a metal through a metal-carbon bond and metal alkoxides in which an organic ligand is coordinated to a metal atom. The former metal alkoxides are substantially limited to silicon compounds. Preferred examples of the latter metal alkoxides include compounds in which a chelate ligand is coordinated to an alkoxide of a transition metal such as Ti, Zr, or Sn.

Specific examples of the former metal alkoxides include methyltrimethoxysilane, ethyltrimethoxysilane, propyltrimethoxysilane, methyltriethoxysilane, ethyltriethoxysilane, propyltriethoxysilane, γ-mercaptopropyltrimethoxysilane, γ-mercaptopropyltriethoxysilane, γ-aminopropyltrimethoxysilane, γ-aminopropyltriethoxysilane, phenyltrimethoxysilane, phenyltriethoxysilane, phenyltripropoxysilane, dimethyldimethoxysilane, dimethyldiethoxysilane, diphenyldimethoxysilane, diphenyldiethoxysilane, and trimethylmethoxysilane.

Preferably, to appropriately control the particle diameter of the sol, a metal alkoxide having one hydrolyzable group, such as trimethylmethoxysilane, is used. Alternatively, a combination of such a metal alkoxide and a second metal alkoxide such as diphenyldimethoxysilane, or diphenyldiethoxysilane is used. The second metal alkoxide has two hydrolyzable groups, and one of the hydrolyzable groups exhibits a low hydrolysis activity and/or a low dehydration condensation activity. When a combination of the above metal alkoxides is used, a preferred amount of the second metal alkoxide is not uniquely determined because it depends on the types of other components. Generally, the amount of the second metal alkoxide is preferably 5 mol % to 90 mol % based on the total amount of the metal alkoxides.

Specific examples of the latter metal alkoxides include titanium diisopropoxy bis(acetylacetonate), titanium dioctyloxy bis(octylene glycolate), titanium diisopropoxy bis(ethyl acetoacetate), zirconium tributoxy mono-acetylacetonate, zirconium monobutoxy acetylacetonate bis(ethyl acetoacetate), and zirconium butoxy bis(ethyl acetoacetate). In the above metal alkoxides, the organic groups are chelate-coordinated to coordination sites of each metal atom, and therefore hydrolysis at these portions is suppressed. For example, in titanium dioctyloxy bis(octylene glycolate), the octylene glycolate ligands are not detached at at least 100° C. or less and remain on the Ti atom. Therefore, if an appropriate combination of the above compounds is used, the particle diameter of the sol can be controlled.

To achieve the dynamic storage elastic modulus required in the present invention, it is preferable to use an appropriate multinuclear metal alkoxide in combination with above metal alkoxides. Preferably, any of metal alkoxides having structures shown in the following formulas (1) to (3) is used.

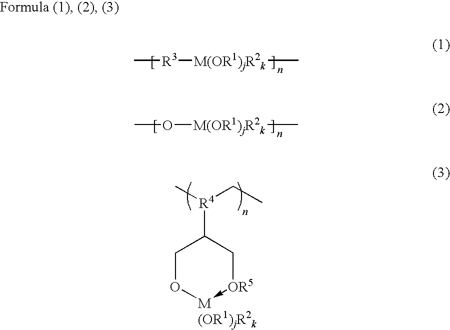

Here, R¹ is a hydrocarbon group having 1 to 12, preferably 1 to 8 carbon atoms, and R² is a non-hydrolyzable organic group or an organic ligand that can be chelate-coordinated to a metal atom through a hydrolyzable or non-hydrolyzable bond and through a non-hydrolyzable coordinate bond. R³ is an organic group that is bonded to an adjacent metal atom M through a non-hydrolyzable bond. R⁴ and R⁵ are organic groups that may contain hetero atoms, and no particular limitation is imposed on their structure. However, since the main chain length of R³ or R⁴ has a large influence on the cross-linking density and elastic modules after sol-gel reaction, a unit having a very long chain is not suitable.

More specifically, the main chain of R³ or R⁴ is composed of preferably 1 to 30 atoms and more preferable 2 to 20 atoms. Preferably, a cyclic structure is introduced into R³ or R⁴ to increase the elastic modulus. (j+k+1) agrees with the valence z of metal atom M. In at least two metal atoms M in the above repetition units, j≧1. k is an integer of 0 or more and (z−j−1) or less. n is the number of repetition units and is determined from the number average molecular weight. n is preferably 2 or more and 100 or less and more preferably 2 or more and 50 or less.

Specific examples of the multinuclear metal alkoxide include silicon compounds such as 1,3-dimethoxytetramethyldisiloxane, 1,1,3,3-tetraethoxy-1,3-dimethyldisiloxane, 1,3-dichloro-1,3-diphenyl-1,3-dimethyldisiloxane, 1,3-dichlorotetraphenyldisiloxane, 1,5-diethoxyhexamethyltrisiloxane, bis(triethoxysilyl)ethane, bis (triethoxysilyl)ethylene, bis(trimethoxysilyl)hexane, 1,4-bis(methoxydimethylsilyl)benzene, 1,4-bis(trimethoxysilylethyl)benzene, bis[3-(trimethoxysilyl)propyl]ethylenediamine, N,N′-bis(hydroxyethyl)-N,N′-bis(trimethoxysilylpropyl)ethylenediamine, bis[3-triethoxysilylpropoxy-2-hydroxypropoxy]polyethylene oxide, and tris(3-trimethoxysilylpropyl)isocyanurate.

Other specific examples of the multinuclear metal alkoxide include titanium compounds such as oligomers obtained by partial hydrolysis of tetraalkoxy titanium. For example, commercial products available from NIPPON SODA CO., LTD. such as organic titanium polymers A-10, B-2, B-4, B-7, and B-10 correspond to the above titanium compounds.

Low-molecular weight polyvinyl alcohols and copolymers thereof may be used as polydentate ligands, and a compound prepared by coordinating such a polydentate ligand to a titanium alkoxide may be used. The same can be applied to other transition metals.

The combined use of the above-exemplified multinuclear metal alkoxide and other metal alkoxides in the starting material for the sol-gel reaction allows an improvement in partial cross-linking density and an improvement in elastic modulus resulting therefrom while an appropriate sol particle diameter is maintained.

The multinuclear metal alkoxide is not limited to those represented by the above formulas (1) to (3). For example, a compound including a combination of a plurality of the structures represented by the formulas (1) to (3) may be used, and a compound including other structures may be used.

A metal alkoxide, such as tetraalkoxysilane or tertraalkoxy titanium, in which hydrolyzable groups are bonded to all the bonding sites may be used in combination with the above-described metal alkoxide having a non-hydrolyzable organic group.

No particular limitation is imposed on the radical-polymerizable monomer. Examples of the radical-polymerizable monomer include (meth)acrylate monomers and vinyl monomers. Specific examples of the (meth)acrylate monomers include: monofunctional (meth)acrylates such as phenoxyethyl (meth)acrylate, 2-methoxyethyl(meth)acrylate, 2-hydroxyethyl (meth)acrylate, benzyl(meth)acrylate, cyclohexyl (meth)acrylate, ethoxydiethylene glycol (meth)acrylate, methoxypolyethylene glycol (meth)acrylate, methyl (meth)acrylate, polyethylene glycol (meth)acrylate, polypropylene glycol (meth)acrylate, and stearyl (meth)acrylate; and polyfunctional (meth)acrylates such as trimethylolpropane tri(meth)acrylate, pentaerythritol tetra(meth)acrylate, dipentaerythritol hexa(meth)acrylate, diethylene glycol di(meth)acrylate, triethylene glycol di(meth)acrylate, tetraethylene glycol di(meth)acrylate, polyethylene glycol di(meth)acrylate, bis(2-hydroxyethyl)isocyanurate di(meth)acrylate, and 2,2-bis[4-(acryloxy diethoxy)phenyl]propane.

Examples of the vinyl monomers include, but not limited to: monofunctional vinyl compounds such as styrene and ethylene glycol monovinyl ether; and polyfunctional vinyl compounds such as divinylbenzene, ethylene glycol divinyl ether, diethylene glycol divinyl ether, and triethylene glycol divinyl ether.

A photo radical generator may be used as the photopolymerization initiator. Examples of the photo radical generator include DAROCUR 1173, IRGACURE 784, IRGACURE 651, IRGACURE 184, and IRGACURE 907 (products of Ciba Specialty Chemicals).

Examples of the additives include: a photosensitizer for improving the reactivity of the photopolymerization initiator at the wavelength of recording light; and a plasticizer that is not involved in the formation of the skeleton of the matrix and in the radical polymerization.

Examples of the photosensitizer include: thioxanthones such as thioxanthen-9-one and 2,4-diethyl-9H-thioxanthen-9-one; xanthenes; cyanines; merocyanines; thiazines; acridines; anthraquinones; and squaryliums. The amount of the photosensitizer used is about 5 to about 50 percent by mass, for example 10 percent by mass, based on the amount of the photopolymerization initiator.

The plasticizer is used for the purpose of improving the mobility of the radical-polymerizable monomer during recording. If the microscopic stiffness of the matrix is excessively high, the mobility of the radical-polymerizable monomer during recording decreases. If the stiffness of the matrix is excessively low, the temporal stability of recorded signals is reduced. Therefore, to ensure the mobility of the radical-polymerizable monomer while the elastic modulus of the recording material is held at a predetermined value, a plasticizer having flowability at least room temperature is used. This is expected to improve the compatibility between the matrix and the radical-polymerizable monomer.

When a desired elastic modulus can be achieved by appropriately selecting the components of the metal alkoxides and the ratio thereof, it is not required to add a plasticizer. When the desired elastic modulus is difficult to achieve, it is effective to add an appropriate plasticizer.

Examples of the plasticizer component include dimethylsiloxane, phenylmethylsiloxane, long-chain alkyl esters, polyethylene glycol, alkyl ethers of polyethylene glycol, polypropylene glycol, alkyl ethers of polypropylene glycol, and polyethylene glycol-polypropylene glycol copolymers (random and block copolymers).

The ratio of the total amount of the metal alkoxides is preferably 50 percent by mass or more and 95 percent by mass or less and more preferably 60 percent by mass or more and 90 percent by mass or less, on the basis of the total amount of the recording material composition after completion of all the preparation processes such as the hydrolysis reaction, the dehydration condensation reaction, and the drying step.

The ratio of the amount of the radical-polymerizable monomer is preferably 5 percent by mass or more and 50 percent by mass or less and more preferably 10 percent by mass or more and 40 percent by mass or less, on the same basis as above.

The ratio of the amount of the photopolymerization initiator is preferably 1 percent by mass or more and 10 percent by mass or less and more preferably 1 percent by mass or more and 5 percent by mass or less, on the same basis as above.

Generally, the ratio of the amount of the plasticizer used as one of the additives is preferably 3 percent by mass or more and 30 percent by mass or less and more preferably 5 percent by mass or more and 20 percent by mass or less, but these ranges are not explicitly specified because they depend on the structures and ratios of other components.

A material other than those described above can be used as the photosensitive material. For example, photosensitive materials exemplified in Japanese Patent Application Laid-Open No. 2008-76674 and having matrices of ionomer resins or polymers having crystalline structures may be used. However, in the Examples of the present invention, the dynamic storage elastic modulus at 80° C. must be equal to or greater than a predetermined value. Therefore, ionomer resins and crystalline polymers having low softening points are not suitable.

More specifically, of the ionomer resins exemplified in Japanese Patent Application Laid-Open No. 2008-76674, styrene-based ionomer resins and fluorine-based ionomer resins that can have high elastic modulus even in a high temperature range may be preferably used. Commercial examples of the styrene-based ionomer resins include AMBERLITE (product of Rohm and Haas Company, U.S.A.) and DIAION (product of Mitsubishi Chemical Corporation). Commercial examples of the fluorine-based ionomer resins include Nafion (product of DuPont, U.S.A.) and Flemion (product of ASAHI GLASS CO., LTD.).

Of the crystalline polymers exemplified in Japanese Patent Application Laid-Open No. 2008-76674, ethylene-vinyl acetate copolymers are preferably used. Commercial examples of the crystalline polymers include Evatate and Sumitate (products of SUMITOMO CHEMICAL Co., Ltd.).

The hologram recording medium 10 was produced by the method described below.

### (Synthesis of Organometallic Sol Solution)

0.49 g of n-butyl alcohol and 0.95 g of 2-methyl-2,4-hydroxy pentane were added to 2.72 g of tetra-n-butoxy titanium (B-1, product of NIPPON SODA CO., LTD.). The mixture was stirred at room temperature to give 4.16 g of a solution of a titanium compound in which two molecules of 2-methyl-2,4-hydroxy pentane were coordinated to one molecule of tetra-n-butoxy titanium.

2.05 g of diphenyldimethoxysilane (LS-5300, product of Shin-Etsu Chemical Co., Ltd.,), 0.79 g of 1,4-bis(trimethoxysilylethyl)benzene (SIB1831.0, product of AZmax Co.), and 0.28 g of 3-acryloxypropyltrimethoxysilane (LS-2827, product of Shin-Etsu Chemical Co., Ltd.) were added to the above-prepared titanium compound solution, and the resultant mixture was used as a metal alkoxide solution. The molar ratio of Ti/Si was 3/5.

A solution containing 0.19 g of pure water, 0.09 g of 2N hydrochloric acid, and 2.00 g of ethanol was added dropwise to the metal alkoxide solution under stirring at room temperature, and the mixture was stirred for 2 hours to allow hydrolysis and condensation reaction to proceed. The ratio of the amount of the metal alkoxide starting material to the total amount of the reaction mixture was 65 percent by mass. An organometallic sol solution was thereby obtained.

### (Photopolymerizable Compound)

80 Parts by weight of methoxypolyethylene glycol acrylate (LIGHT-ACRYLATE 130A, product of KYOEISHA CHEMICAL Co., LTD.) and 20 parts by weight of propylene glycol acrylate (BLEMMER AP-550, product of NOF CORPORATION) were mixed. 3 Parts by weight of IRGACURE 907 (product of Ciba Specialty Chemicals) used as the photopolymerization initiator and 0.3 parts by weight of thioxanthen-9-one used as the photosensitizes were added to the mixture to give a solution containing the photopolymerizable compounds.

### (Hologram Recording Material Solution)

The above-prepared sol solution and the above-prepared photopolymerizable compound solution were mixed at room temperature such that the amount of the matrix material was 85 parts by weight (as the non-volatile component of the starting material) and the amount of the photopolymerizable material was 15 parts by weight, whereby a substantially colorless clear hologram recording material solution was obtained. The obtained hologram recording material composition solution was applied to a glass substrate 14 and dried in the manner described below to give a recording medium sample.

A 1 mm-thick glass substrate 14 having an antireflection film 22 on one side was prepared. A spacer 18 having a predetermined thickness was placed on the glass substrate 14 on the side opposite to the antireflection film 22. The above-obtained hologram recording material solution was applied to that side of the glass substrate 14 and dried at room temperature for 2 hours and at 80° C. for 72 hours to volatilize the solvent. In this drying step, a hologram recording material having a dry thickness of 300 μm was obtained with the organometallic compound and the photopolymerizable compound uniformly dispersed therein.

The obtained recording film was easily dissolvable in general purpose organic solvents such as acetone and methyl ethyl ketone, and a uniform clear solution was obtained. Therefore, it is clear that the matrix in this recording material is formed by three-dimensional cross linking through intermolecular force not through covalent bonds.

### (Hologram Recording Medium)

The hologram recording material formed on the glass substrate 14 was covered with a 1 mm-thick glass substrate 16 having an antireflection film 24 disposed on one side. The glass substrate 16 was carefully placed such that air bubbles were not present at the interface between the hologram recording material layer and a surface of the glass substrate 16 on the side opposite to the antireflection film 24. A hologram recording medium 10 having the hologram recording material layer sandwiched between the two glass substrates was thereby obtained.

### (Measurement of Dynamic Viscoelasticity)

The dynamic storage elastic modulus (dynamic shear storage elastic modulus) of the recording material was measured according to JIS K7244-10:2005 (ISO6721-10:1999) using the procedure described below. The measurement was carried out using a viscoelastic measurement apparatus RheoStress RS6000 (product of Thermo Fisher Scientific Inc., Germany).

A spacer the same as that used to produce the hologram recording medium was placed on the metal-made sample stage of the apparatus, and a film of the hologram recording medium was produced in the manner described above. A glass cover was not placed on the produced film. The dynamic viscoelasticity of the film formed on the sample stage was measured under the conditions listed below. The measurement was carried out for each of a sample before exposure to light and a sample after the monomer was polymerized using the same procedure as that described later.

Measurement temperature: 30 to 105° C.

Temperature rising rate: 2° C./min

Measurement frequency: 1 Hz

Stress: 30 Pa

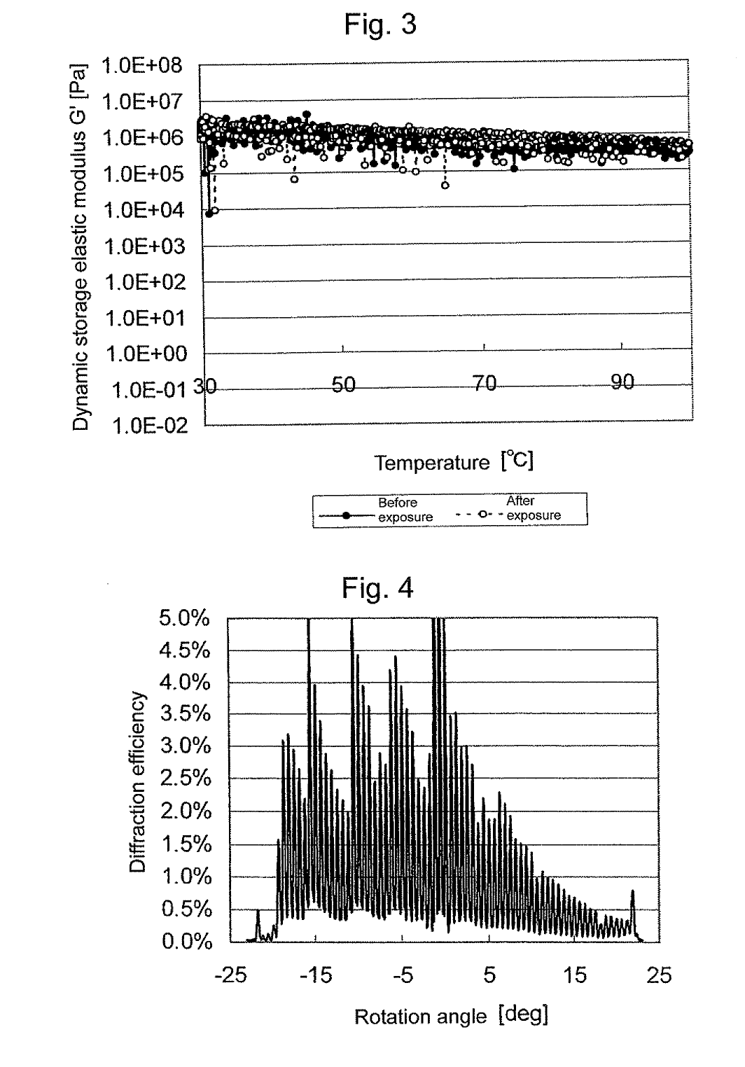

The temperature dependence profiles of the measured dynamic storage elastic modulus are shown in FIG. 3. The values of the dynamic storage elastic modulus at 60° C., 80° C., and 100° C. are shown in Table 1.

TABLE 1

Dynamic storage elastic modulus G′ [Pa]

| Temperature | Before exposure | After exposure |
|---|---|---|
| 60° C. | 7.56E+5 | 1.18E+6 |
| 80° C. | 3.79E+5 | 8.09E+5 |
| 100° C. | 3.19E+5 | 5.00E+5 |

### (Characteristics Evaluation)

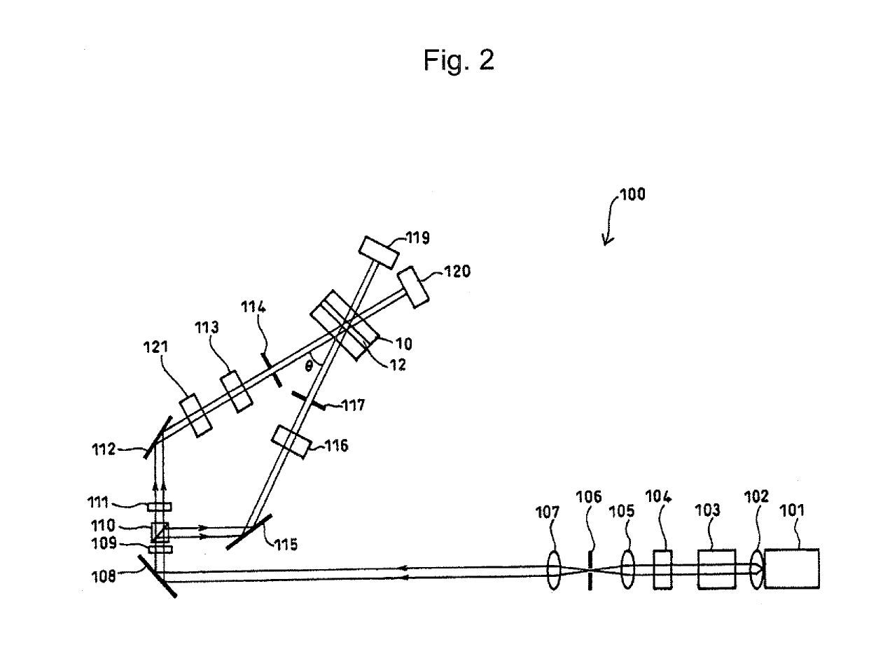

The characteristics of the obtained hologram recording medium 10 were evaluated using a hologram recording optical system 100 shown in FIG. 2. In FIG. 2, directions on the page surface are defined as horizontal directions for convenience. In FIG. 2, the hologram recording medium 10 was placed such that the recording material layer was perpendicular to the page surface.

In the hologram recording optical system 100 shown in FIG. 2, a single-mode oscillation semiconductor laser light source 101 (wavelength: 405 nm) was used. The light emitted from the light source was subjected to spatial filtering through a beam shaper 102, an optical isolator 103, a shutter 104, a convex lens 105, a pinhole 106, and a convex lens 107, and was collimated to obtain a beam having an expanded beam diameter of about 10 mm.

The expanded beam was reflected by a mirror 108 and passed through a ½ wave plate 109 to obtain a 45′ polarized beam, and the polarized beam was split by a polarizing beam splitter 110 (s-wave beam/p-wave beam=1/1). The split s-wave beam traveled by way of a mirror 115, a polarizing filter 116, and an iris diaphragm 117, and the split p-wave beam was converted to an s-wave beam by a ½ wave plate 111 and traveled by way of a mirror 112, a polarizing filter 113, and an iris diaphragm 114. The two beams were then incident on the hologram recording medium 10 such that the angle θ between the two beams was 43°, whereby interference fringes were recorded. In the hologram recording optical system 100, a sample holder for holding the hologram recording medium 10 was secured to a resettable plate. The resettable plate was designed such that the recording medium can be detached for a storage test described later and can be attached again with the attachment position controlled accurately.

A hologram was recorded while the hologram recording medium 10 was rotated in the horizontal directions, i.e., angular multiplexing was employed (sample angle: −21° to +21°, angular interval: 0.6°). The degree of multiplexing was 71. During recording, the diameters of the iris diaphragms were set to 4 mm to expose the recording medium to light. The sample angle was set to ±0° when the sample surface was perpendicular to the bisector of the angle between the two light beams.

To complete the reaction of the remaining unreacted components after the hologram recording, the entire surface of the hologram recording medium 10 was sufficiently irradiated with light from a blue LED (wavelength: 400 nm). At this time, the exposure to light was carried out through an acrylic resin-made diffuser plate having a transmittance of 80% so that reference light did not have coherence (this process is referred to as post-curing).

During reproduction, a shutter 121 was closed to block one of the two light beams, and only one light beam was applied with the diameter of the iris diaphragm 117 set to 1 mm. The hologram recording medium 10 was continuously rotated from −23° to +23° in the horizontal direction, and the diffraction efficiency at each angle was measured using a power meter.

When a change in volume (recording shrinkage) and a change in average refractive index of the recording material layer do not occur before and after recording, diffraction peak angles in the horizontal direction during recording and diffraction peak angles during reproduction are the same. However, in practice, recording shrinkage and a change in average refractive index occur, so that the diffraction peak angles in the horizontal direction during reproduction slightly deviate from those during recording.

Therefore, during reproduction, the angle of the hologram recording medium 10 in the horizontal direction was continuously changed, and the values of the diffraction efficiency were determined using the peak intensities of diffraction peaks emerging during rotation. The diffraction profile obtained is shown in FIG. 4.

The dynamic range M/# (the sum of the square roots of the values of diffraction efficiency at the diffraction peaks) was 22.8 (a converted value for a hologram recording material layer having a thickness of 1 mm).

### (Storage Test)

The temporal stability of the interferential fringes recorded by angular multiplexing described in the characteristics evaluation was measured using the following method.

The angle-multiplex-recorded hologram recording medium 10 held by the sample holder was detached from the resettable plate together with the sample holder. The hologram recording medium 10 and the sample holder were placed in an oven with internal air circulation and heated at 80° C. for 14 days (336 hours). Then the oven was gradually cooled to room temperature, and the recorded interference fringes were reproduced.

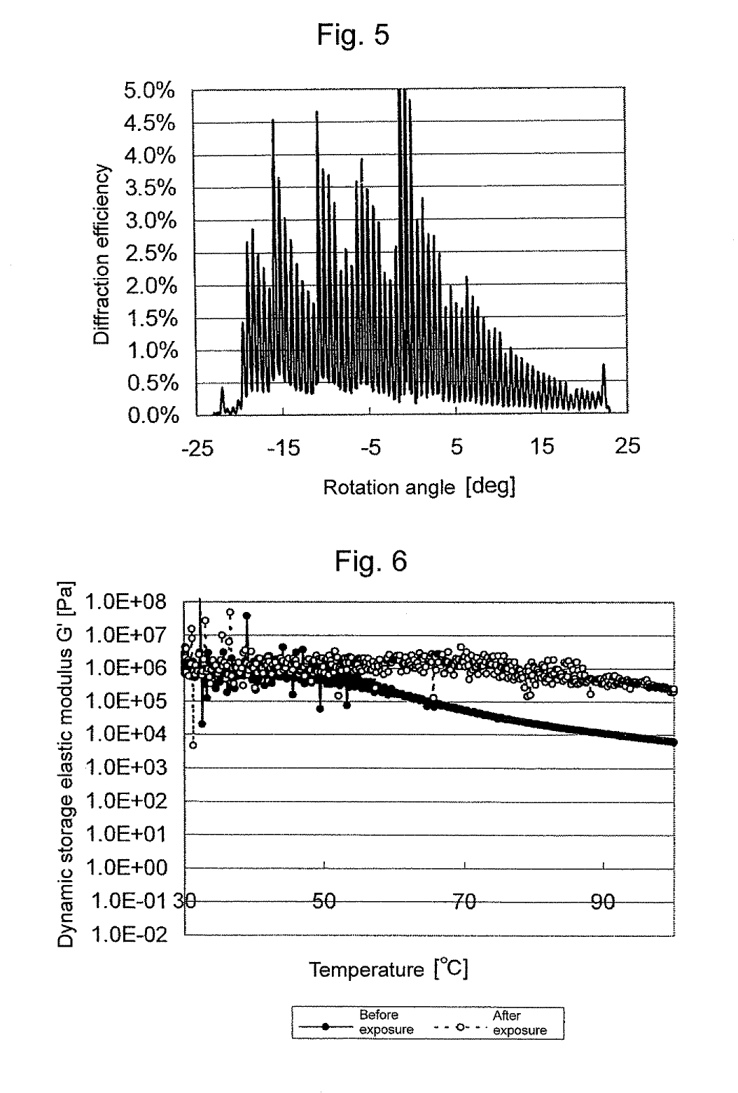

The obtained M/# was 21.8, and almost no reduction from the initial value was found. The diffraction profile in this case is shown in FIG. 5. As can be seen, the diffraction profile is substantially unchanged.

### Example 2

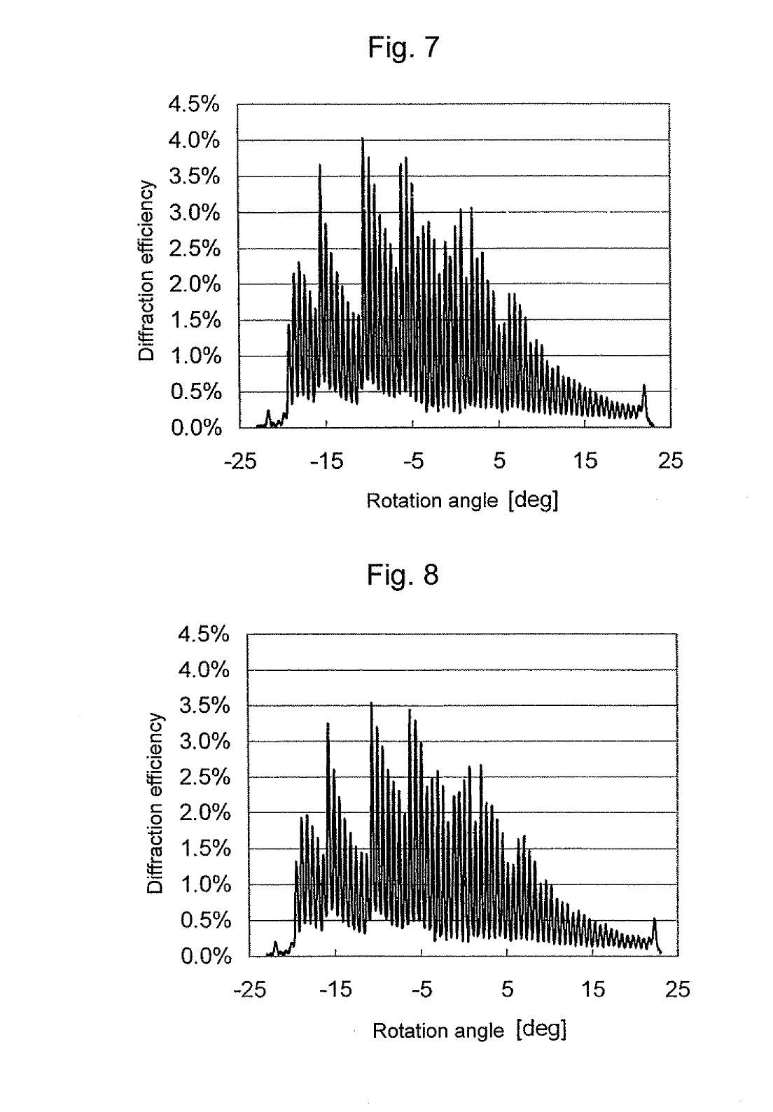

The same procedure as in Example 1 was repeated to prepare a hologram recording medium sample, except that an organometallic sol solution was synthesized using a procedure described below. The dynamic viscoelasticity was measured using this sample in the same manner as in Example 1. The results are shown in FIG. 6 and Table 2. The evaluation of recording characteristics and the storage test were carried out using the same procedures as in Example 1 (FIGS. 7 and 8 and Table 3).

The obtained recording material film was easily dissolvable in general purpose organic solvents such as acetone and methyl ethyl ketone, as in Example 1, and a uniform clear solution was obtained. Therefore, it is clear that the matrix in this recording material is formed by three-dimensional cross linking through intermolecular force not through covalent bonds.

### (Synthesis of Organometallic Sol Solution)

0.49 g of n-butyl alcohol and 0.95 g of 2-methyl-2,4-hydroxy pentane were added to 2.72 g of tetra-n-butoxy titanium (9-1, product of NIPPON SODA CO., LTD.), and the mixture was stirred at room temperature to give 4.16 g of a solution of a titanium compound in which two molecules of 2-methyl-2,4-hydroxy pentane were coordinated to one molecule of tetra-n-butoxy titanium.

1.54 g of diphenyldimethoxysilane (LS-5300, product of Shin-Etsu Chemical Co., Ltd.,), 0.39 g of 1,4-bis(trimethoxysilylethyl)benzene (SIB1831.0, product of AZmax Co.), and 0.19 g of 3-acryloxypropyltrimethoxysilane (LS-2827, product of Shin-Etsu Chemical Co., Ltd.) were added to the above-prepared titanium compound solution, and the resultant mixture was used as a metal alkoxide solution. The molar ratio of Ti/Si was 9/10.

A solution containing 0.15 g of pure water, 0.06 g of 2N hydrochloric acid, and 1.50 g of ethanol was added dropwise to the metal alkoxide solution under stirring at room temperature, and the mixture was stirred for 2 hours to allow hydrolysis and condensation reaction to proceed. The ratio of the amount of the metal alkoxide starting material to the total amount of the reaction mixture was 65 percent by mass. An organometallic sol solution was thereby obtained.

TABLE 2

Dynamic storage elastic modulus G′ [Pa]

| Temperature | Before exposure | After exposure |
|---|---|---|
| 60° C. | 1.72E+5 | 1.98E+6 |
| 80° C. | 2.13E+4 | 1.20E+6 |
| 100° C. | 6.26E+3 | 2.22E+5 |

TABLE 3

| | Initial value | 80° C./after 14 days |
|---|---|---|
| M/# | 22.3 | 21.2 |

As can be seen from these results, the information recording layers of the hologram recording mediums in Examples 1 and 2 were formed of materials having dynamic storage elastic moduli of 1.0×10⁵ Pa or more as measured at 80° C. and a measurement frequency of 1 Hz after interferential exposure or post-curing. These materials were found to have dynamic storage elastic moduli of 1.0×10⁴ Pa or more as measured at 80° C. and a measurement frequency of 1 Hz before interferential exposure.

### Comparative Example 1

### Synthesis of Organometallic Sol Solution

0.49 g of n-butyl alcohol and 0.95 g of 2-methyl-2,4-hydroxy pentane were added to 2.72 g of tetra-n-butoxy titanium (B-1, product of NIPPON SODA CO., LTD.), and the mixture was stirred at room temperature to give 4.16 g of a solution of a titanium compound in which two molecules of 2-methyl-2,4-hydroxy pentane were coordinated to one molecule of tetra-n-butoxy titanium.

1.62 g of diphenyldimethoxysilane (LS-5300, product of Shin-Etsu Chemical Co., Ltd.,) was added to the above-prepared titanium compound solution, and the resultant mixture was used as a metal alkoxide solution. The molar ratio of Ti/Si was 1/1.

A solution containing 0.09 g of pure water, 0.04 g of 2N hydrochloric acid, and 0.75 g of ethanol was added dropwise to the metal alkoxide solution under stirring at room temperature, and the mixture was stirred for 2 hours to allow hydrolysis and condensation reaction to proceed. The ratio of the amount of the metal alkoxide starting material to the total amount of the reaction mixture was 65 percent by mass. An organometallic sol solution was thereby obtained.

### (Photopolymerizable Compound)

80 Parts by weight of methoxypolyethylene glycol acrylate (LIGHT-ACRYLATE 130A, product of KYOEISHA CHEMICAL Co., Ltd.) and 20 parts by weight of propylene glycol acrylate (BLEMMER AP-550, product of NOF CORPORATION) were mixed. 3 Parts by weight of IRGACURE 907 (product of Ciba Specialty Chemicals) used as the photopolymerization initiator and 0.3 parts by weight of thioxanthen-9-one used as the photosensitizer were added to the mixture to give a solution containing the photopolymerizable compounds.

### (Hologram Recording Material Solution)

The above-prepared sol solution and the above-prepared photopolymerizable compound solution were mixed at room temperature such that the amount of the matrix material was 90 parts by weight (as the non-volatile component of the starting material) and the amount of the photopolymerizable material was 10 parts by weight, whereby a substantially colorless clear hologram recording material solution was obtained.

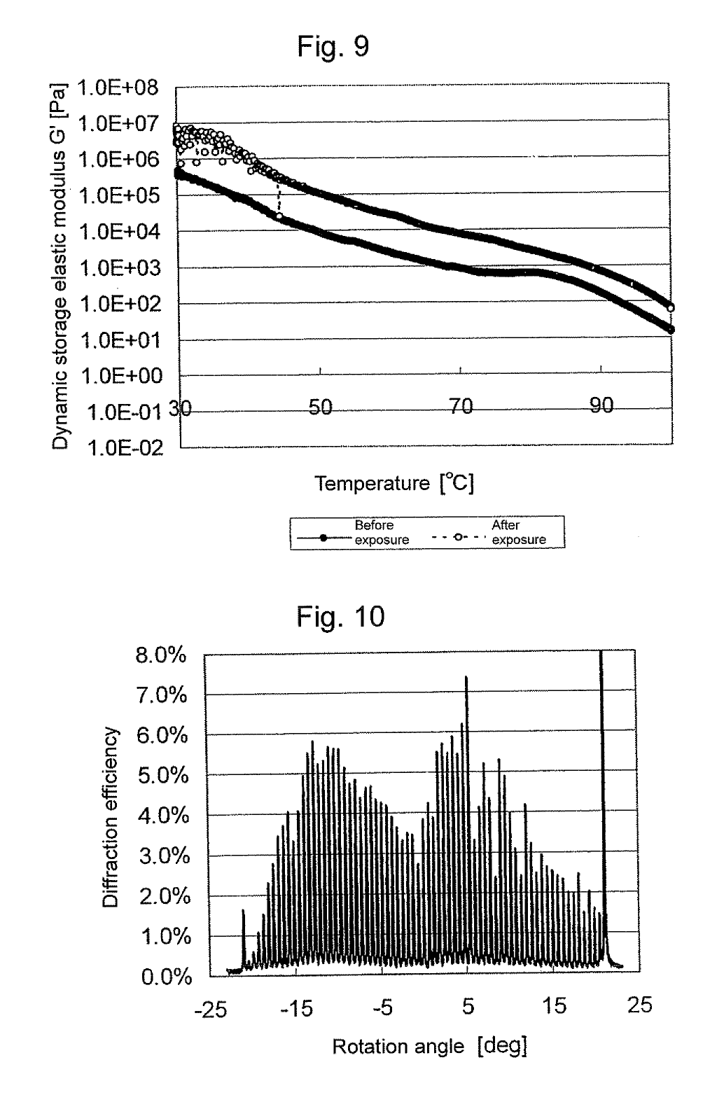

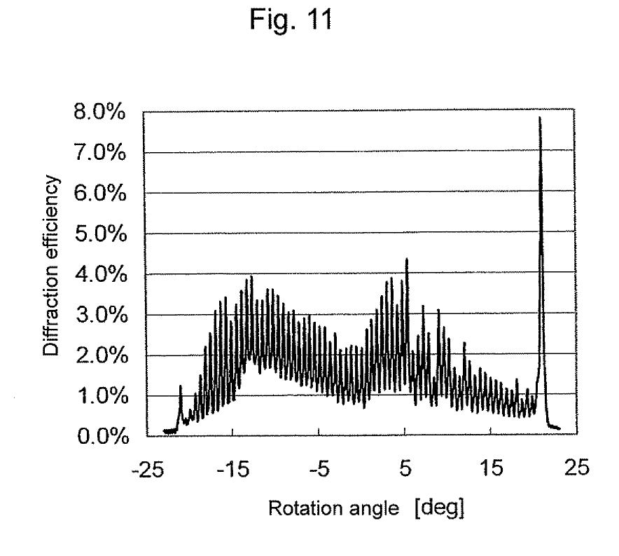

A hologram recording medium was produced using the above-prepared hologram recording material solution in the same manner as in Example 1, and the dynamic viscoelasticity of the obtained hologram recording medium was evaluated in the same manner as in Example 1 (FIG. 9 and Table 4). In addition, the characteristics before and after storage at 80° C. were evaluated in the same manner as in Example 1 (FIGS. 10 and 11 and Table 5).

As can be seen from these figures and tables, in Comparative Example 1, the dynamic storage elastic modulus decreased steeply as temperature increased. Therefore, in the reproduction test after storage at 80° C., M/# decreased significantly, and the diffraction profile was largely changed.

TABLE 4

Dynamic storage elastic modulus G′ [Pa]

| Temperature | Before exposure | After exposure |
|---|---|---|
| 60° C. | 2.41E+3 | 2.72E+4 |
| 80° C. | 6.22E+2 | 2.69E+3 |
| 100° C. | 1.59E+1 | 6.75E+1 |

TABLE 5

| | Initial value | 80° C./after 14 days |
|---|---|---|
| M/# | 27.0 | 21.7 |

With the hologram recording materials in Examples 1 and 2, a matrix that is three-dimensionally cross linked through intermolecular force can be obtained, and hologram recording mediums having sufficient storage stability can thereby be obtained. Such hologram recording materials, unlike a conventional hologram recording material having a matrix cross-linked three-dimensionally through covalent bonds, can be dissolved or dispersed in an appropriate organic solvent even after the formation of the matrix. Therefore, a recording medium can be easily manufactured by using any of the above recording materials dispersed in an appropriate solvent and applying it using a conventional coating method such as spin coating, dip coating, or gravure coating.

The use of such a coating method allows the recording material to be easily applied to a large-area flexible substrate in a continuous manner. Therefore, various optical devices other than hologram recording mediums, such as decoration and anti-counterfeit hologram sheets and hologram screens for displaying three-dimensional images can be easily mass-produced at low cost. Since the storage stability required for such optical devices is substantially the same as that for the above optical recording mediums, photosensitive materials such as the hologram recording materials in Examples 1 and 2 are suitably used for these optical devices.

Specific examples of the decoration hologram sheets include hologram sheets described in Japanese Patent Application Laid-Open Nos. Hei. 11-249536 and 2005-309452. Specific examples of the hologram screens for displaying three-dimensional images include screens described in WO 99/50702.

No particular limitation is imposed on the upper limit of the dynamic storage elastic modulus of the hologram information recording layer in each of Examples 1 and 2 as measured at 80° C. and a measurement frequency of 1 Hz after interference exposure or post-curing. Desirably, the upper limit is about 1.0×10⁹ Pa. No particular limitation is imposed on the upper limit of the dynamic storage elastic modulus as measured at 80° C. and a measurement frequency of 1 Hz before interference exposure. Desirably, the upper limit is about 1.0×10⁸ Pa.

The glass substrates of the hologram recording mediums in Examples 1 and 2 may be transparent substrates made of resin.

The present invention can be used in various optical devices such as hologram optical recording mediums, decoration and anti-counterfeit hologram sheets, and hologram screens for displaying three-dimensional images.

What is claimed is:

1. An optical device, comprising: a supporting substrate; and an information recording layer that is supported on the supporting substrate and has a photosensitivity for recording a hologram by irradiation with light, wherein
the photosensitive material has a dynamic storage elastic modulus of 1.0×10⁵ Pa or more as measured at 80° C. and a measurement frequency of 1 Hz after interference exposure or post-curing.

2. The optical device according to claim 1, wherein the information recording layer has a dynamic storage elastic modulus of 1.0×10⁴ Pa or more as measured at 80° C. and a measurement frequency of 1 Hz before the interference exposure.

3. The optical device according to claim 1, wherein the information recording layer contains 5 percent by mass to 50 percent by mass of a radical-polymerizable monomer.

4. The optical device according to claim 2, wherein the information recording layer contains 5 percent by mass to 50 percent by mass of a radical-polymerizable monomer.

5. The optical device according to claim 1, wherein the information recording layer is dissolvable or dispersible in an organic solvent.

6. The optical device according to claim 2, wherein the information recording layer is dissolvable or dispersible in an organic solvent.

7. The optical device according to claim 3, wherein the information recording layer is dissolvable or dispersible in an organic solvent.
